(19) United States
(12) Patent Application Publication
(10) Pub. No.: US 2016/0052805 A1
(43) Pub. Date: Feb. 25, 2016

(54) ELECTRO-COAGULATION AND METAL SAND TREATMENT FOR WASTEWATER

(71) Applicant: HALLIBURTON ENERGY SERVICES, INC., Houston, TX (US)

(72) Inventors: Charles R. Landis, The Woodlands, TX (US); Shantel J. Stone, Conroe, TX (US); David M. Donald, Houston, TX (US)

(21) Appl. No.: 14/781,465

(22) PCT Filed: Jan. 28, 2014
(86) PCT No.: PCT/US14/13289

§ 371 Date: Sep. 30, 2015

(51) Int. Cl. C02F 1/463; C02F 1/00; C02F 1/42; C02F 1/44

(52) U.S. Cl. CPC C02F 1/463; C02F 1/441; C02F 1/008; C02F 1/004; C02F 1/42; C02F 2103/10

(57) ABSTRACT

Improved methods and systems for treating wastewaters produced in mining and/or subterranean well bore operations are provided. In one embodiment, the systems comprise: an electro-coagulation unit that receives wastewater from a wastewater source, performs an electro-coagulation treatment on the wastewater using one or more EC cells, and produces a first fluid stream that comprises one or more solid materials and a liquid effluent; a solids separation unit coupled downstream of and in fluid communication with the electro-coagulation unit that separates at least a portion of the solid materials in the first fluid stream from the liquid effluent; and a filter comprising a metal-bearing filtration media coupled downstream of and in fluid communication with the solids separation unit that filters the liquid effluent from the solids separation unit to produce a treated water stream.

### BACKGROUND

The present disclosure relates to methods and systems for use in mining and/or subterranean well bore operations, and more specifically, to improved methods and systems for treating wastewaters produced in those operations.

Mining operations and various types of subterranean well bore operations (e.g., drilling, fracturing, etc.) sometimes generate large volumes of waste water, such as produced water, surface water, flowback water, and the like. This waste water is typically collected into various ponds or sumps at a job site, and eventually it is transferred to a main holding area or sump. From here, the water may be transferred to a water treatment plant for processing before discharge to the environment.

Waste water may contain a variety of components. The water often comprises dilute slurry comprising finely divided particulates or other undissolved solids, either indigenous to the subterranean formation or mine site or a by-product of a mining or well treatment operation. In addition to the particulate matter, the waste water also often contains dissolved solids, particularly metals such as zinc, iron, cadmium, lead, copper, arsenic, and the like. The composition and concentration of these dissolved metals will vary from site to site and with the operations of the individual sites. The pH of the waste water also may vary with the site and its operations.

Various water treatment methods have been used to decrease the concentration of contaminants in waste water, including but not limited to electro-coagulation (“EC”) treatments. However, such conventional EC treatments alone only may be able to reduce concentrations of contaminants such as arsenic by about 80% to 95% by weight, which may not be adequate to meet various environmental or toxicity standards that govern the disposal of wastewater. Other treatment methods have been developed to further reduce concentrations of these contaminants; however, many of those methods require large equipment that may not be practical for transportation or use at a job site. Moreover, many other water treatment methods rely on the use of chemical additives such as coagulants or precipitants to remove contaminants in the water. However, storage, handling, and/or transportation of these additives at or to a jobsite may increase the cost and complexity of those operations.

### BRIEF DESCRIPTION OF THE FIGURES

Some specific example embodiments of the disclosure may be understood by referring, in part, to the following description and the accompanying drawings.

FIG. 1 is a diagram illustrating an example of a wastewater treatment system may be used in accordance with certain embodiments of the present disclosure.

FIG. 2 is a diagram illustrating another example of a wastewater treatment system may be used in accordance with certain embodiments of the present disclosure.

While the present disclosure is susceptible to various modifications and alternative forms, specific example embodiments have been shown in the figures and are herein described in more detail. It should be understood, however, that the description of specific example embodiments is not intended to limit the claims to the particular forms disclosed. On the contrary, this disclosure is to cover all modifications and equivalents as illustrated, in part, by the appended claims.

### DESCRIPTION

The present disclosure relates to methods and systems for use in mining and/or subterranean well bore operations, and more specifically, to improved methods and systems for treating wastewaters produced in those operations.

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

The methods and systems of the present disclosure generally involve a two-step treatment of wastewater that comprises an electro-coagulation (EC) and floc settling treatment, followed by a chemical filtration treatment using metal-bearing filtration media such as metal-bearing sand. In certain embodiments, a treatment system of the present disclosure may comprise an EC unit comprising one or more EC cells that receive the waste water, a solids separation unit that separates coalesced solid materials (e.g., including semi-solids) from the liquid portion of the EC effluent, and a filtration unit comprising a metal-bearing filtration media that filters the EC effluent to remove additional contaminants. These methods and systems may be used to remove suspended and/or dissolved solids from the waste water and produce treated water. Following treatment according to the present disclosure, the treated water may be may be disposed of safely, or may be used in further operations at the well site or mining site (including former well or mining sites and/or abandoned well or mining sites).

Among the many potential advantages of the present disclosure, the methods and systems of the present disclosure may, among other things, reduce the concentration of contaminants in waste water to levels required by various standards. In certain embodiments, the methods and systems of the present disclosure may reduce the concentration of certain contaminants (e.g., arsenic) in wastewater to less than about 1% of the original concentration of those contaminants in the wastewater. In certain embodiments, the methods and systems of the present disclosure may reduce the concentration of total suspended solids and/or total dissolved solids in the wastewater. In certain embodiments, the methods and systems of the present disclosure may use fewer chemical additives than other types of waste water treatments, which may make these methods and systems more environmentally-friendly and/or may reduce the cost and/or safety risks associated with handling such chemical additives and/or transporting them to a well site or mining site. Certain systems of the present disclosure also may have a relatively small operational footprint, which may make them more practical for use at a well site or mining site.

The methods and systems of the present disclosure may be used to reduce the concentration of any contaminant found in waste water, including but not limited to arsenic, calcium, manganese, sulfate, cadmium, copper, lead, mercury, nickel, iron, magnesium, uranium, antimony, chromium, zinc, and the like. In certain embodiments, the methods and systems of the present disclosure may be capable of treating wastewater to meet certain maximum contamination standards without the use of reverse osmosis and/or other conventional water treatment methods. In other embodiments, the treatment using EC and filtration using metal-bearing sand optionally may be combined with other treatment methods such as reverse osmosis, exchange resins, ultra-filtration, chemical coagulation treatments, and the like, among other reasons, to achieve more complete removal of contaminants in the waste water. Such treated water may be disposed of safely, or may be used in further operations at the well site or mining site.

EC is an electro-chemical process in which waste water is passed through an EC cell, which typically includes a housing or vessel in which one or more pairs of conductive metal electrodes (e.g., metal plates) are placed in parallel that act as anodes and cathodes. The electrodes may be connected to a power source and a device (e.g., a controller) for regulating current density across the plates. The electrodes may be made of a suitable electrically conductive material, such as iron, aluminum, titanium, graphite, steel, and alloys or combinations thereof The EC cell may further comprise a fluid inlet through which a fluid may be introduced into the housing and a fluid outlet through which treated fluid may be expelled. In the housing, the untreated water stream may be flowed between and past the pairs of electrodes while exposed to the direct current voltage across the plate electrodes. Not seeking to be bound by theory, application of a voltage to the electrodes may cause metal from a negative electrode of a given electrode pair to ionize and enter into the untreated water flowing through the housing. The newly formed metal ions may react with contaminants in the fluid, causing such contaminants or a portion thereof to become coalesced (e.g., coagulated or precipitated) in the fluid, for example, as solids or semi-solids. Depending on the chemistry of the wastewater, the coalesced materials may float or sink where they may be separated from the remaining EC effluent using various types of solids separation techniques, including but not limited to passive/gravity separation, dissolved air flotation, induced air flotation, circular clarification techniques, centrifugation, and the like. Additional separation of coalesced materials may be achieved by flotation of gas bubbles generated at the cathode. In certain embodiments, the coalesced materials and flocs may be separated from the water in a solids separation unit, which may include devices such as clarification tanks, skimmers, filters, weirs, circular clarifiers, dissolved/induced air flotation units, centrifuges, and the like. In certain embodiments, an EC unit may comprise multiple EC cells into which waste water may be pumped substantially simultaneously. In certain embodiments, one or more components (e.g., EC unit, the separating unit, etc.) may be a mobile unit that can be transported to and from a well site or mining site as desired. In certain embodiments, the controls for operating the EC cells and/or other components of the EC unit may be partially or completely automated, or configured to be operated from a remote location, for example, via a communications network as described below. One example of an EC system that may be suitable for use in certain embodiments of the present disclosure is the EC system used in the CleanWave® system and services available from Halliburton Energy Services, Inc.

The EC effluent is then filtered through metal-bearing filtration media in the methods and systems of the present disclosure. This filtration treatment performs a chemical filtration function due to the reduction-oxidation reaction that occurs between the metal in the filtration media and the electrically-charged contaminants in the EC effluent. The metal-bearing filtration media may comprise one or more silicate minerals that include metallic atoms. The metallic component of the metal-bearing filtration media may comprise any metal or combination thereof, including but not limited to iron, aluminum, copper, zircon, titanium, magnesium, chrome, and the like. One example of a metal-bearing sand that may be a suitable filtration media for certain embodiments of the present disclosure is “green sand”, which comprises manganese-coated glauconite. In certain embodiments, the particular type of metal in the filtration media may be selected for its reactivity with certain contaminants expected to be present in the EC effluent. For example, iron-bearing filtration media may be selected for its capability of chemically reacting with arsenic and antimony in wastewater. A person of skill in the art with the benefit of this disclosure will recognize the appropriate metals to use for particular contaminants based upon, among other things, their known reactivity. This filtration treatment also may perform both a physical filtration function by trapping particulate solids and/or dissolved solids as the EC effluent passes through the filter. In certain embodiments, the particle size of the filtration media may be optimized to trap dissolved contaminants while still allowing water to flow through. For example, dissolved solids may be assumed to have a particle size of about 44 microns, and thus the particle and pore sizes of the filtration media may be adjusted to trap particles of that size. In certain embodiments, the metal-bearing filtration media may have a pore size of about 15 microns or less.

In certain embodiments, the wastewater, EC effluent and/or filtration effluent may be exposed to one or more pre-treatments prior to the EC and/or filtration steps. For example, in certain embodiments, the wastewater and/or EC effluent may be aerated or oxygenated, for example, by bubbling air therethrough, in order to optimize EC treatment and/or the redox reactions with the metal-bearing filtration media. In certain embodiments, the pH of the waste water, EC effluent, and/or filtration effluent may be adjusted, among other reasons, to optimize the effectiveness of the following treatment, or to make the effluent or treated water suitable for disposal or use in subsequent operations. This may be accomplished using any means known in the art, including but not limited to the addition of chemical pH-adjusting additives (e.g., salts). In certain embodiments, the pH of the wastewater may be adjusted to a range of 3.5-4.5 prior to the EC treatment. The filtration media also may be prepared, cleaned, and/or regenerated in certain embodiments of the present disclosure using any means known in the art.

As noted above, the methods and systems of the present disclosure may incorporate additional wastewater treatment steps or techniques, among other reasons, to more completely remove contaminants from the wastewater or to reduce concentrations of contaminants that the EC and filtration steps do not significantly reduce. In certain embodiments, the EC effluent may be filtered through a conventional filtration media (e.g., silica or quartz sand) prior to filtration through the metal-bearing media. In other embodiments, ultra-filtration methods may be used (e.g., after filtration through the metal-bearing media) to remove organic materials and/or small flocs from the wastewater, for example, by using membrane filters having pore sizes of about 0.04 microns. Examples of other treatments that may be incorporated include, but are not limited to, reverse osmosis treatments, exchange resin treatments, and the like.

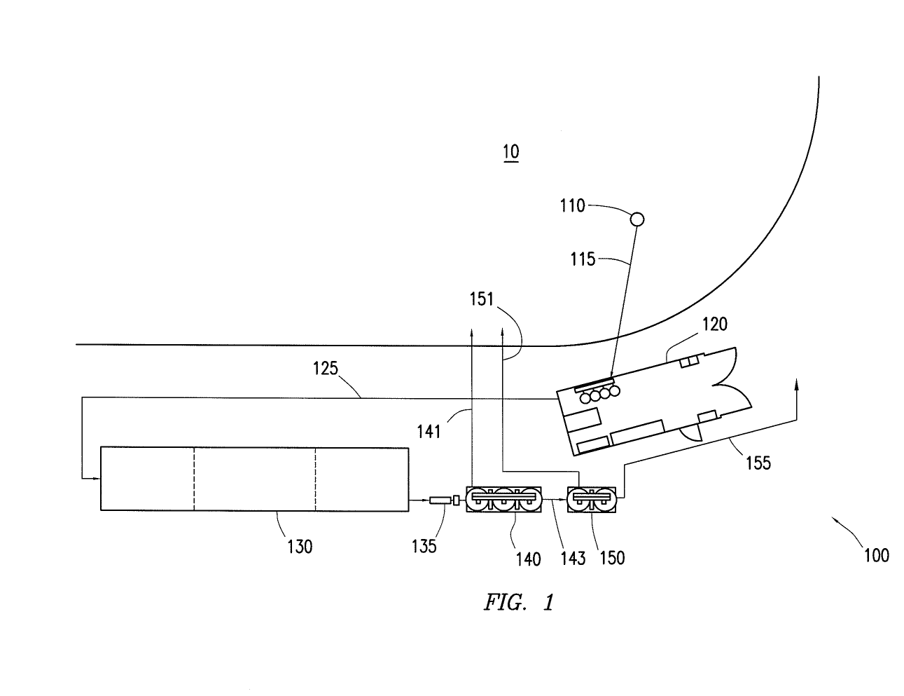

FIG. 1 illustrates one embodiment of a wastewater treatment system 100 according to the present disclosure. System 100 is shown at a site that includes a retention pond 10 where the wastewater to be treated is held. Feed pump 110 is used to move wastewater from pond 10 through fluid conduit 115 into the EC unit 120. Prior to the EC treatment, feed pump 110 or another subsystem also may perform an aerating or oxygenation function by bubbling air through the wastewater, which may further oxidize certain contaminants in the wastewater in preparation for the EC treatment. The EC unit includes a subsystem (not shown) for mixing the wastewater with one or more pH adjusting additives, and a plurality of EC cells in which the wastewater is introduced and treated. The effluent from the EC treatment flows through conduit 125 to solids separation unit 130, which may include a weir tank or other solids separation equipment to separate the coalesced solids in the EC effluent from the water. In certain embodiments, the separated water also may be treated in solids separation unit 130 with chemical oxidation additives or further bubbling of oxygen or air.

The separated fluid then flows through conduit 135 to an optional sand filter 140 which filters the water through a silicate sand media. When the sand filter 140 is flushed with fluid to clean it, the flushed fluid may be returned to retention pond 10 through conduit 141. The filtrate then flows through conduit 143 into the metal sand filter 150 where it is filtered through the metal-bearing filtration media. When the metal sand filter 150 is flushed with fluid to clean it, the flushed fluid may be returned to retention pond 10 through conduit 151. The filtrate from metal sand filter 150 may flow out of the system via conduit 155, which may direct the treated water to any desired location either onsite or offsite for use, storage, and/or disposal. Although not shown in FIG. 1, the system 100 optionally may comprise one or more flow control devices (e.g., pumps, valves, and the like) located at various points in the system to control the flow of fluids through the fluid conduits to and from the various units in the system. System 100 also may comprise one or more sample ports (not shown) located at various points in the system (e.g., in fluid conduits 115, 135, and/or 155) where samples of the wastewater may be taken for evaluating contaminant concentration levels at various points during the treatment process.

In certain embodiments, the effluent and/or filtrate flowing out of the EC unit, solids separation unit, metal sand filter, and/or one or more of the other optional units in the system may be directed to one or more water quality monitoring (WQM) units (not shown), which may monitor the amounts of certain contaminants in those fluids. For example, a water quality monitoring unit may be placed along conduit 155 to monitor concentration of contaminants in the filtrate flowing out of the metal sand filter 150. In certain embodiments, if the amount of a contaminant in the fluid exceeds a certain amount, the fluid flowing into the WQM unit may be re-directed to a retention pond and/or one of the upstream treatment units in the system (e.g., the EC unit). The WQM units may comprise any WQM system known in the art. Such units may be operated manually by an operator (either on-site or off-site), or may be configured to monitor contaminant concentrations and/or re-direct fluids out of compliance with certain pre-determined contaminant concentration levels automatically. In certain embodiments, these units may be configured to monitor contaminant concentration levels in real-time with the water treatment process. In certain embodiments, the WQM system may generate data relating to concentrations of one or more contaminants, which may be displayed and/or stored on site, or may be sent off-site, for example, to an information handling system and/or remote real time operating center, as described in further detail below.

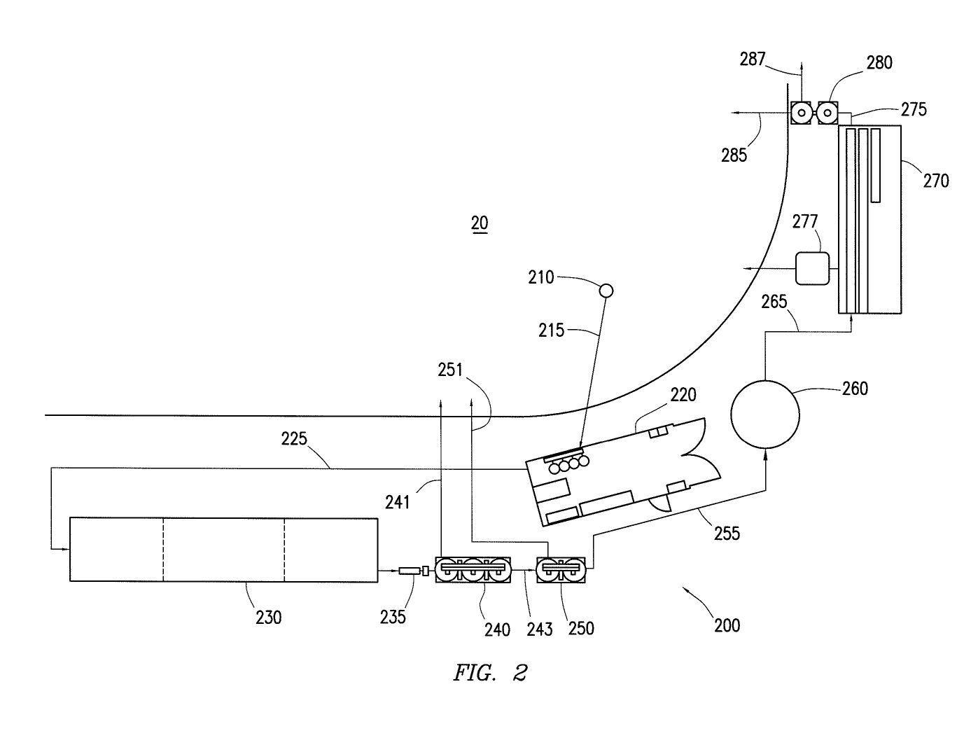

FIG. 2 illustrates another embodiment of a wastewater treatment system 200 according to the present disclosure. System 200 includes many of the same components and equipment as shown in FIG. 1, including feed pump 210, EC unit 220, solids separation unit 230, sand filter 240, metal sand filter 250, and fluid conduits 215, 225, 235, 241, and 243 (as well as optional sample ports, pumps, valves, or other flow control devices). Following filtration in metal sand filter 250, the filtrate may flow through conduit 255 to a reverse osmosis surge tank 260 where the fluid is held prior to flowing through conduit 265 to reverse osmosis unit 270 for treatment to remove additional contaminants. The concentrate collected in the reverse osmosis membrane may be returned to retention pond 20 via conduit 277. The water flowing out of reverse osmosis unit 270 flows through conduit 275 to resin treatment unit 280 where the water may be treated with ion exchange resins to remove additional contaminants. When the resin bed in resin treatment unit 280 is flushed with fluid to clean it, the flushed fluid may be returned to retention pond 20 through conduit 285. The water flowing out of the resin treatment unit 280 may flow out of the system via conduit 287, which may direct the treated water to any desired location either onsite or offsite for use, storage, and/or disposal.

In certain embodiments, the EC unit, pumps, valves, WQM units, and/or other components of a system of the present disclosure may be operated and/or monitored using an information handling system, controller, or special purpose computer located at the well site or mining site, remotely from the well site or mining site, or some combination thereof For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer or tablet device, a cellular telephone, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system also may include one or more buses operable to transmit communications between the various hardware components.

Any suitable processing application software package may be used by the information handling system to process the data. Examples of special purpose computer systems programmed to perform these functions include, but are not limited to, those used in the SENTRY™ and INSITE™ services and systems provided by Halliburton Energy Services, Inc. The information handling system may be communicatively coupled by wireline or wirelessly to other equipment to receive data from various components of a treatment system of the present disclosure.

An information handling system used to operate and/or monitor a treatment system of the present disclosure also may be communicatively coupled to a network, such as a local area network or the Internet, either directly or through one or more input/output devices (e.g., an external communications interface). In certain embodiments, such a network may permit the data from the information handling system to be remotely accessible by any computer system communicatively coupled to the network via, for example, a satellite, a modem or wireless connections. As would be appreciated by those of ordinary skill in the art, with the benefit of this disclosure, a controller and/or computer system communicatively coupled to the information handling system also may collect data from multiple sites to perform quality checks across a plurality of sites. The information handling system also may be communicatively coupled to, for example, a remote real time operating center whereby the remote real time operating center is able to send and/or receive data from the information handling system. In certain embodiments, the data may be pushed at or near real-time enabling real-time communication, monitoring, and reporting capability. This may, among other benefits, allow an operator to continuously monitor exhaust emissions at a job site, and allow the received data to be used in a streamline workflow in a real-time manner by other systems and operators concurrently with acquisition.

The systems and methods of the present disclosure may be used to treat wastewater produced in conjunction with any mining or well site operation. For example, the systems and methods of the present disclosure may be used in fracturing operations, drilling operations, completions operations, cleanout operations, and/or cementing operations. A person of skill in the art, with the benefit of this disclosure, will recognize how to apply or implement the systems and methods of the present disclosure as disclosed herein in a particular operation.

The terms “couple” or “couples,” as used herein are intended to mean either an indirect or a direct connection. Thus, if a first device couples to a second device, that connection may be through a direct connection, or through an indirect connection via other devices and connections. The term “coupled in fluid communication” as used herein is intended to mean coupling of components in a way to permit the flow of fluids (e.g., liquids or gases) therebetween. Such coupling may be accomplished via a direct connection or an indirect connection with one or more intervening components that permit the flow of fluids therethrough. The term “communicatively coupled” as used herein is intended to mean coupling of components in a way to permit communication of information therebetween. Two components may be communicatively coupled through a wired or wireless communication network, including, but not limited to, Ethernet, LAN, fiber optics, radio, microwaves, satellite, and the like. Operation and use of such communication networks is well known to those of ordinary skill in the art and will, therefore, not be discussed in detail herein.

In one embodiment, the present disclosure provides a system comprising: an electro-coagulation unit that receives wastewater from a wastewater source, performs an electro-coagulation treatment on the wastewater using one or more EC cells, and produces a first fluid stream that comprises one or more solid materials and a liquid effluent; a solids separation unit coupled downstream of and in fluid communication with the electro-coagulation unit that separates at least a portion of the solid materials in the first fluid stream from the liquid effluent; and a filter comprising a metal-bearing filtration media coupled downstream of and in fluid communication with the solids separation unit that filters the liquid effluent from the solids separation unit to produce a treated water stream.

In another embodiment, the present disclosure provides a method comprising: providing wastewater at a job site; performing an electro-coagulation treatment on the wastewater to produce a first fluid stream that comprises one or more solid materials and liquid effluent; separating at least a portion of the solid materials from the liquid effluent; and filtering at least a portion of the liquid effluent through a filter comprising a metal-bearing filtration media to produce a treated water stream.

In another embodiment, the present disclosure provides a system comprising: an electro-coagulation unit that receives wastewater from a wastewater source, performs an electro-coagulation treatment on the wastewater using one or more EC cells, and produces a first fluid stream that comprises one or more solid materials and a liquid effluent; a first conduit coupled in fluid communication with the electro-coagulation unit that receives the first fluid stream; a solids separation unit coupled in fluid communication with the first conduit that receives the first fluid stream from the first conduit and separates at least a portion of the solid materials from the liquid effluent; a second conduit coupled in fluid communication with the solids separation unit that receives the liquid effluent; a sand filter coupled in fluid communication with the second conduit that receives the liquid effluent from the second conduit and filters the liquid effluent to produce a second fluid stream; a third conduit coupled in fluid communication with the sand filter that receives the second fluid stream; and a filter comprising a metal-bearing filtration media coupled in fluid communication with third conduit that receives the second fluid stream from the third conduit and filters the second fluid stream to produce a treated water stream.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A system comprising:
an electro-coagulation unit that receives wastewater from a wastewater source, performs an electro-coagulation treatment on the wastewater using one or more EC cells, and produces a first fluid stream that comprises one or more solid materials and a liquid effluent;
a solids separation unit coupled downstream of and in fluid communication with the electro-coagulation unit that separates at least a portion of the solid materials in the first fluid stream from the liquid effluent; and
a filter comprising a metal-bearing filtration media coupled downstream of and in fluid communication with the solids separation unit that filters the liquid effluent from the solids separation unit to produce a treated water stream.

2. The system of claim 1 wherein the solids separation unit comprises a weir tank.

3. The system of claim 1 further comprising a sand filter coupled between the solids separation unit and the filter comprising a metal-bearing filtration media, said sand filter filtering at least a portion of the liquid effluent from the solids separation unit before it reaches the filter comprising a metal-bearing filtration media.

4. The system of claim 1 further comprising a conduit coupled downstream of and in in fluid communication with the filter comprising a metal-bearing filtration media that transports the treated water stream to a location for disposal or use in further operations.

5. The system of claim 1 further comprising
a reverse osmosis unit coupled downstream of and in fluid communication with the filter comprising a metal-bearing filtration media that performs a reverse osmosis treatment on the treated water stream to produce a reverse-osmosis treated water stream; and
a conduit coupled downstream of and in fluid communication with the reverse osmosis unit that transports the reverse-osmosis treated water stream to a location for disposal or use in further operations.

6. The system of claim 1 further comprising
a resin treatment unit coupled downstream of and in fluid communication with the filter comprising a metal-bearing filtration media that performs a resin polish treatment on the treated water stream to produce a resin-treated water stream; and
a conduit coupled downstream of and in fluid communication with the resin treatment unit that transports the resin-treated water stream to a location for disposal or use in further operations.

7. The system of claim 1 wherein one or more components of the system are communicatively coupled to an information handling system at a remote location that receives data from the one or more components of the system and operates one or more components of the system.

8. The system of claim 7 wherein the information handling system receives data relating to a concentration of one or more contaminants in the treated water stream.

9. The system of claim 1 further comprising a water quality monitoring unit coupled downstream of and in fluid communication with the filter comprising a metal-bearing filtration media that monitors the concentration of one or more contaminants in the treated water stream.

10. The system of claim 9 wherein the water quality monitoring unit is communicatively coupled to an information handling system that receives data relating to the concentration of one or more contaminants in the treated water stream.

11. The system of claim 1 wherein the system does not include any of a reverse-osmosis treatment unit, an ultra-filtration unit, or a resin treatment unit.

12. A method comprising:
providing wastewater at a job site;
performing an electro-coagulation treatment on the wastewater to produce a first fluid stream that comprises one or more solid materials and liquid effluent;
separating at least a portion of the solid materials from the liquid effluent; and
filtering at least a portion of the liquid effluent through a filter comprising a metal-bearing filtration media to produce a treated water stream.

13. The method of claim 12 further comprising the step of filtering at least a portion of the liquid effluent through a filter comprising a sand filtration media before the step of filtering at least a portion of the liquid effluent through the filter comprising a metal-bearing filtration media.

14. The method of claim 12 further comprising determining the concentration of one or more contaminants in the treated water stream.

15. The method of claim 14 wherein data relating to the concentration of one or more contaminants in the treated water stream is sent to an information handling system at a remote location.

16. The method of claim 12 wherein the wastewater comprises an initial concentration of arsenic, and the concentration of arsenic in the third fluid stream is less than about 1% of the original arsenic concentration in the wastewater.

17. The method of claim 12 wherein the treated water stream is not treated with any of a reverse-osmosis treatment, an ultra-filtration treatment, or a resin treatment.

18. The method of claim 12 wherein the job site comprises a mining site.

19. A system comprising:
an electro-coagulation unit that receives wastewater from a wastewater source, performs an electro-coagulation treatment on the wastewater using one or more EC cells, and produces a first fluid stream that comprises one or more solid materials and a liquid effluent;
a first conduit coupled in fluid communication with the electro-coagulation unit that receives the first fluid stream;
a solids separation unit coupled in fluid communication with the first conduit that receives the first fluid stream from the first conduit and separates at least a portion of the solid materials from the liquid effluent;
a second conduit coupled in fluid communication with the solids separation unit that receives the liquid effluent;
a sand filter coupled in fluid communication with the second conduit that receives the liquid effluent from the second conduit and filters the liquid effluent to produce a second fluid stream;
a third conduit coupled in fluid communication with the sand filter that receives the second fluid stream; and
a filter comprising a metal-bearing filtration media coupled in fluid communication with third conduit that receives the second fluid stream from the third conduit and filters the second fluid stream to produce a treated water stream.

20. The system of claim 18 further comprising a water quality monitoring unit coupled downstream of and in fluid communication with the filter comprising the metal-bearing filtration media that monitors the concentration of one or more contaminants in the treated water stream.
